(19) United States
(12) Patent Application Publication
(10) Pub. No.: US 2024/0219678 A1
(43) Pub. Date: Jul. 4, 2024

(54) OPTICAL COMPONENT

(71) Applicant: TDK TAIWAN CORP., Taoyuan City (TW)

(72) Inventors: Po-Xiang ZHUANG, Taoyuan City (TW); Chao-Yuan CHANG, Taoyuan City (TW); Wei-Jhe SHEN, Taoyuan City (TW); Sin-Jhong SONG, Taoyuan City (TW); Kun-Shih LIN, Taoyuan City (TW); Yi-Ho CHEN, Taoyuan City (TW); Chao-Chang HU, Taoyuan City (TW)

(21) Appl. No.: 18/400,877

(22) Filed: Dec. 29, 2023

Related U.S. Application Data
(60) Provisional application No. 63/436,291, filed on Dec. 30, 2022.

(51) Int. Cl. G02B 7/04

(52) U.S. Cl. CPC G02B 7/04

(57) ABSTRACT

An optical component is provided. The optical component includes a movable part, a fixed part, and a driving assembly. The movable part is for connecting an optical element. The movable part is movable relative to the fixed part. The driving assembly is for driving the movable part to move relative to the fixed part.

### CROSS REFERENCE TO RELATED APPLICATIONS

This application claims the benefit of U.S. Provisional Application No. 63/436,291, filed 2022 Dec. 30, the entirety of which is incorporated by reference herein.

### BACKGROUND OF THE INVENTION

### Field of the Invention

The present invention relates to an optical component, and, in particular, to an optical component having a guiding assembly.

### Description of the Related Art

With the development of science and technology, many electronic devices (such as notebook computers, smart phones and digital cameras) have the function of taking pictures and recording videos. The use of these electronic devices is becoming more and more common. In addition to developing more stable and better optical quality, newer models also have convenient and thin designs that provide users with more choice.

In view of this, there is a need for an optical component that allows the optical photography focal length to be adjusted to adapt to different external photography needs. At the same time, it may reduce operational errors caused by interference with magnetic elements during operation, stabilize the internal structure, and provide more stability and better optical quality.

### BRIEF SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate parts of the entire specification of this disclosure, any or all drawings, and each claim.

According to certain aspects of the present disclosure, an optical component is provided. The optical component includes a movable part, a fixed part, and a driving assembly. The movable part connects an optical element. The fixed part includes a housing, and the movable part moves relative to the fixed part. The driving assembly drives the movable part to move relative to the fixed part.

According to certain aspects of the present disclosure, the movable part includes a first magnetic element, a second magnetic element, and the optical component further includes a sensing element. The first magnetic element and the second magnetic element are disposed on the movable part. The first magnetic element corresponds to the sensing element. The volume of the first magnetic element is different from the volume of the second magnetic element. The volume of the first magnetic element is larger than the volume of the second magnetic element.

According to certain aspects of the present disclosure, the fixed part has a main axis, and the housing has an elongated structure. The fixed part includes a top plate. The top plate is made of magnetically permeable material and has an extending direction perpendicular to the main axis. The top plate has a first opening and a second opening, and the first opening corresponds to the first magnetic element. The second opening corresponds to the second magnetic element. The area of the first opening is different from the area of the second opening. The shape of the first opening corresponds to the shape of the first magnetic element, and is larger than the shape of the first magnetic element, and the shape of the second opening corresponds to and is larger than the shape of the second magnetic element. The magnetic pole direction of the first magnetic element is arranged along the main axis.

According to certain aspects of the present disclosure, the driving assembly includes a first magnetic unit, a first coil, a second magnetic unit, and a second coil. The first magnetic unit has an elongated structure. The first coil has an elongated structure and corresponds to the first magnetic unit. The second magnetic unit has an elongated structure. The second coil has an elongated structure and corresponds to the second magnetic unit.

According to certain aspects of the present disclosure, when viewed along the main axis, the first magnetic unit and the first coil extend along a first axis. The second magnetic unit and the second coil extend along a second axis. The main axis is perpendicular to the second axis. The housing extends along the second axis. The first axis and the second axis are perpendicular to each other.

According to certain aspects of the present disclosure, the first magnetic unit is closer to the first magnetic element than the second magnetic unit. The second magnetic unit is closer to the second magnetic element than the first magnetic unit. The shortest distance between the first magnetic unit and the first magnetic element is different from the shortest distance between the second magnetic unit and the second magnetic element. The shortest distance between the first magnetic unit and the first magnetic element is greater than the shortest distance between the second magnetic unit and the second magnetic element.

According to certain aspects of the present disclosure, the magnetic pole direction of a first magnetic part of the first magnetic unit is arranged along the second axis. The magnetic pole direction of a second magnetic part of the first magnetic unit is arranged along the second axis. The magnetic pole direction of the second magnetic part of the first magnetic unit is opposite to the magnetic pole direction of the first magnetic part of the first magnetic unit. The magnetic pole direction of the first magnetic element is perpendicular to the magnetic pole direction of the first magnetic part of the first magnetic unit and the magnetic pole direction of the second magnetic part.

According to certain aspects of the present disclosure, when viewed along the main axis, the maximum size of the first magnetic unit on the second axis is different from the maximum size of the second magnetic unit on the first axis. The maximum size of the first magnetic unit on the first axis is the same as the maximum size of the second magnetic unit on the second axis. The maximum size of the first coil on the first axis is the same as the maximum size of the second coil on the second axis. The maximum size of the first magnetic unit on the second axis is greater than the maximum size of the second magnetic unit on the first axis.

According to certain aspects of the present disclosure, the optical component further includes a guiding assembly, through which the movable part is movable relative to the fixed part. The top plate further has a third opening and a fourth opening. The guiding assembly has a first guiding element and a second guiding element. The first guiding element has an elongated structure and passes through the third opening. The second guiding element has an elongated structure and passes through the fourth opening. The third opening has a closed structure. The first opening has an open structure.

According to certain aspects of the present disclosure, the fixed part further includes an outer frame, the guiding assembly positions the outer frame, and the outer frame is fixedly disposed on the fixed part.

According to certain aspects of the present disclosure, the magnetic permeability of the outer frame is lower than the magnetic permeability of the top plate. The top plate further includes an optical opening. The outer frame includes a frame opening. The frame opening corresponds to the optical opening. The structures of the first opening and the second opening are connected with the optical opening.

According to certain aspects of the present disclosure, the outer frame at least partially overlaps the first opening when viewed along the main axis. The area of the frame opening is smaller than the total area of the first opening, the second opening, and the optical opening.

According to certain aspects of the present disclosure, the movable part further has a first corner, a second corner, a third corner, and a fourth corner. When viewed along the main axis, the first magnetic element and the second magnetic element are located on two sides of the optical opening. The first magnetic element and the second magnetic element are located at the first corner and the third corner, and the first corner and the third corner are opposite corners. The first guiding element and the second guiding element are located at the second corner and the fourth corner, and the second corner and the fourth corner are opposite corners.

According to certain aspects of the present disclosure, the outer frame includes a first frame and a second frame, the first frame is located between the second frame and the top plate. The Young's modulus of the first frame is different from the Young's modulus of the second frame. The Young's modulus of the first frame is greater than the Young's modulus of the second frame.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a front perspective view of an optical component, according to certain aspects of the present disclosure.

FIG. 2 is an exploded perspective view of the optical component and the optical element, according to certain aspects of the present disclosure.

FIG. 3A is a top view of the movable part, the driving assembly, and a first guide rod and a second guide rod of the guiding assembly, according to certain aspects of the present disclosure.

FIG. 3B is a top view of the movable part, the driving assembly, the first guide rod and the second guide rod of the guiding assembly, and a second frame of the fixed part, according to certain aspects of the present disclosure.

FIG. 4 is a top view of the optical component and the optical element, according to certain aspects of the present disclosure, the top cover, the module sponge, and the first frame is removed for illustrative purposes.

FIG. 5 is a schematic diagram of the magnetic distribution of the first magnetic element, the second magnetic element, the first magnetic unit, and the second magnetic unit, according to certain aspects of the present disclosure.

### DETAILED DESCRIPTION OF THE INVENTION

Various embodiments are described with reference to the accompanying drawings, wherein like reference characters are used to designate similar or equivalent elements throughout. The drawings are not to scale and are provided solely to illustrate features and characteristics of the present disclosure. It is understood that many specific details, relationships, and methods are set forth to provide a comprehensive understanding. However, one of ordinary skill in the art will readily recognize that various embodiments may be practiced without one or more of the specific details or in other ways. In some instances, well-known structures or operations are not shown in detail for illustrative purposes. Various embodiments are not limited to the order in which actions or events are displayed, as some actions may occur in a different order and/or concurrently with other actions or events. Furthermore, not all actions or events shown may be required to implement certain aspects and characteristics of the present disclosure.

For the purposes of this embodiment, unless expressly stated otherwise, the singular includes the plural and vice versa. The term “including” means, “including without limitation”. In addition, similar words such as “about (bout, almost, substantially, approximately)” and similar words may here mean, for example, “at”, “near, nearly at”, “at 3% “Within 3-5% of”, “within acceptable manufacturing tolerances” or any logical combination thereof. Additionally, the terms “vertical” or “horizontal” are intended to additionally include “within 3-5%” of the vertical or horizontal direction, respectively. In addition, directional terms such as “top,” “bottom,” “left,” “right,” “above,” and “below” are intended to relate to the equivalent directions depicted in the reference illustration; from the reference object or component Understood in context, such as from the usual position of the object or element; or such other description.

It will be understood that, although the terms “first”, “second”, etc. may be used herein to describe various elements, layers and/or portions, these elements, layers and/or portions should not be referred to as such. The terms are limited and are only used to distinguish between different components, layers and/or sections. Thus, a first element, layer and/or section discussed below could be termed a second element, layer and/or section without departing from the teachings of some embodiments of the present disclosure. In addition, for the sake of simplicity, terms such as “first” and “second” may not be used to distinguish different components in the specification. Without departing from the scope defined in the appended patent application, the first element and/or the second element described in the patent application may be interpreted as any element consistent with the description in the specification.

The present disclosure relates to an optical component, which has a guiding assembly. The guiding assembly is driven by a driving assembly to drive the movable part and the optical element, thereby adjusting the photographic imaging of the optical component to adapt to different photographic needs.

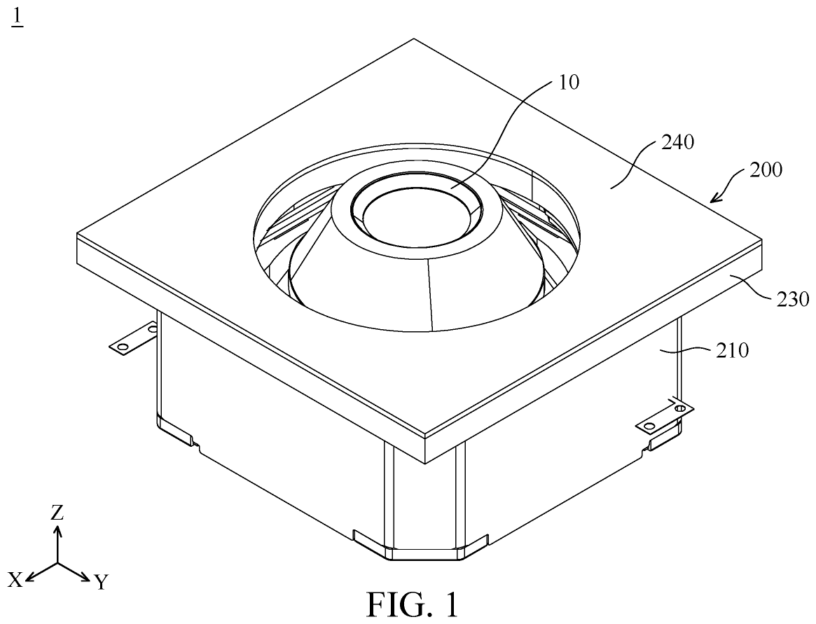

First, please refer to FIG. 1. FIG. 1 is a front perspective view of an optical component 1 and an optical element 10, according to certain aspects of the present disclosure.

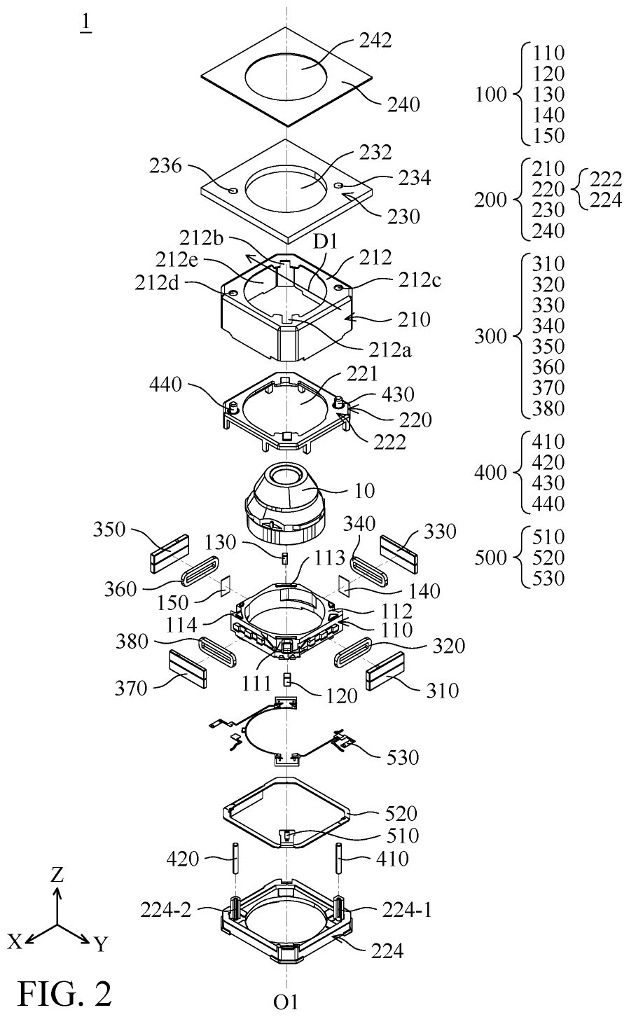

Please refer to FIG. 2. FIG. 2 is an exploded perspective view of the optical component 1 and the optical element 10, according to certain aspects of the present disclosure. The optical component 1 includes a movable part 100, a fixed part 200, a driving assembly 300, a guiding assembly 400, and an electronic assembly 500. The movable part 100 is connected to an optical element 10, and the optical element 10 may be, for example, an optical lens. The movable part 100 may move relative to the fixed part 200, and the driving assembly 300 drives the movable part 100 to move relative to the fixed part 200.

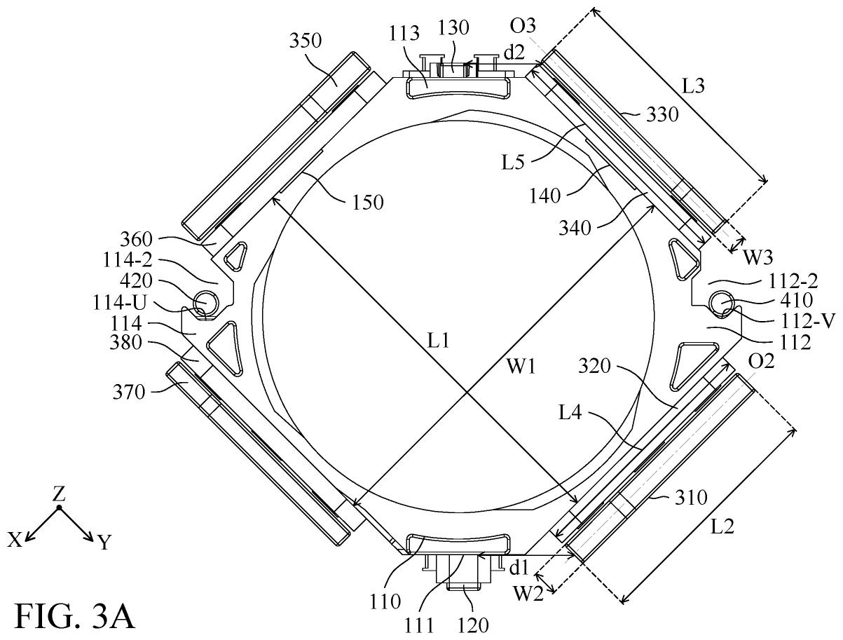

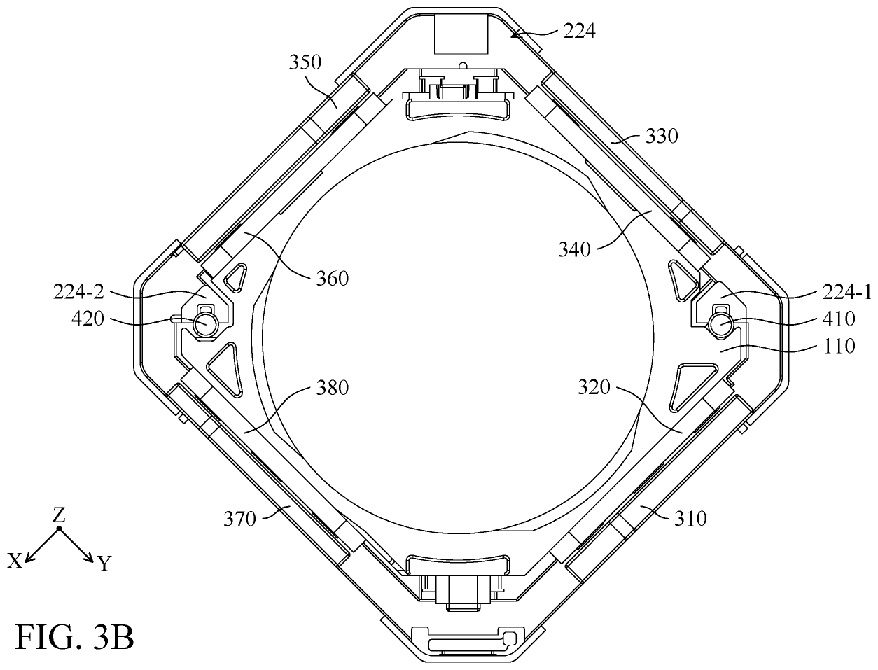

The movable part 100 has a movable part body 110, a first magnetic element 120, a second magnetic element 130, a third magnetic element 140, and a fourth magnetic element 150. The first magnetic element 120, the second magnetic element 130, the third magnetic element 140 and the fourth magnetic element 150 are disposed on the movable part body 110 of the movable part 100. Please refer to FIG. 3A. FIG. 3A is a top view of the movable part 100, the driving assembly 300, and a first guide rod 410 and a second guide rod 420 of the guiding assembly 400, according to certain aspects of the present disclosure. In some embodiments, the movable part body 110 has a length L1 and a width W1 that are different from each other, that is, the four sides of the movable part body 110 are not of equal length. In some embodiments, the length L1 of the movable part body 110 is greater than the width W1. In other embodiments, the movable part body 110 may have generally the same length and width.

The movable part body 110 has four corners, a first corner 111, a second corner 112, a third corner 113, and a fourth corner 114. The first magnetic element 120 and the second magnetic element 130 are located at the first corner 111 and the third corner 113, and the first corner 111 and the third corner 113 are opposite corners. The second corner 112 and the fourth corner 114 are opposite corners.

The second corner 112 has a V-shaped groove 112-V and a recess 112-2. The V-shaped groove 112-V is for accommodating the first guide rod 410 of the guiding assembly 400. Please refer to FIG. 3B. FIG. 3B shows a top view of the movable part 100, the driving assembly 300, the first guide rod 410 and the second guide rod 420 of the guiding assembly 400, and a second frame 224 of the fixed part 200, according to certain aspects of the present disclosure. The recess 112-2 is for engaging a protruding column 224-1 of the second frame 224 of the fixed part 200 to accommodate the first guide rod 410 between the movable part 100 and the fixed part 200.

Next, please refer to FIG. 3A and FIG. 3B together. The fourth corner 114 has a U-shaped groove 114-U and a recess 114-2. The U-shaped groove 114-U is for accommodating the second guide rod 420 of the guiding assembly 400, and the recess 114-2 is for engaging a protruding column 224-2 of the second frame 224 of the fixed part 200 to accommodate the second guide rod 420 between the movable part 100 and the fixed part 200.

The first magnetic element 120 is a permanent magnet, which serves as a sensing magnet and corresponds to a sensing element 510 on the electronic assembly 500 (see FIG. 2). When the movable part 100 moves relative to the fixed part 200, the sensing element 510 senses changes in the magnetic field of the first magnetic element 120 to sense the movement of the movable part 100.

In this embodiment, the third magnetic element 140 and the fourth magnetic element 150 may be, for example, magnetically permeable sheets, and the movable part 100 is attracted to the direction of a second magnetic unit 330 and a third magnetic unit 350 of the driving assembly 300. The direction of attraction force is such that the movable part body 110 leans against the first guide rod 410 and the second guide rod 420 and further against the second frame 224.

The second magnetic element 130 is a permanent magnet, which serves as a balancing magnet to prevent the movable part 100 from being affected by the magnetic field (for example, affected by the first magnetic element 120, the third magnetic element 140, or the fourth magnetic element 150) when moving and being flipped. In some embodiments, the volume of the first magnetic element 120 is different from the volume of the second magnetic element 130. In this embodiment, the volume of the first magnetic element 120 is larger than the volume of the second magnetic element 130.

Please refer to FIG. 2 again. The fixed part 200 has a main axis O1. The fixed part 200 includes a housing 210, an outer frame 220, a top cover 230, and a module sponge 240. The housing 210 has an elongated structure. The housing 210 includes a top plate 212. The top plate 212 is made of magnetically permeable material and has an extension direction D1. The extension direction D1 is perpendicular to the main axis O1. The top plate 212 has a first opening 212a, a second opening 212b, a third opening 212c, a fourth opening 212d, and an optical opening 212e.

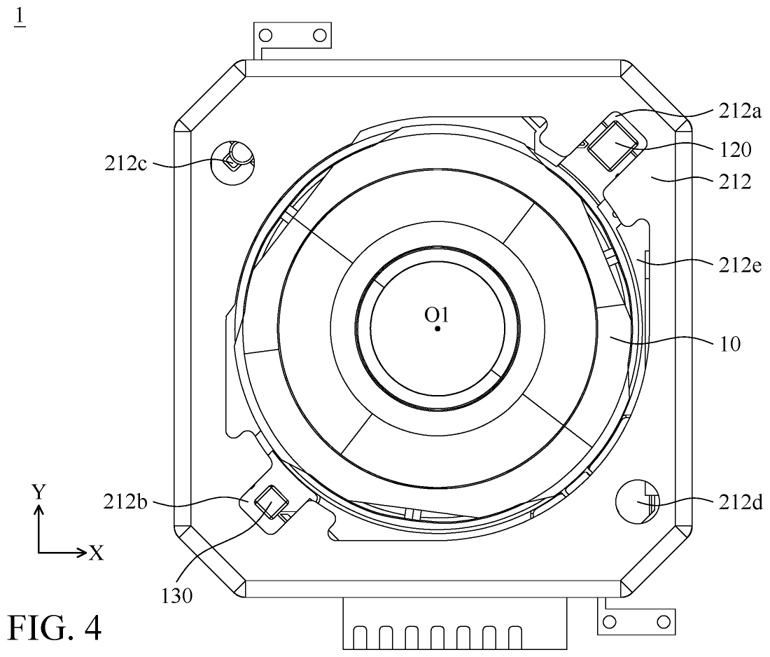

Next, please see FIG. 4. FIG. 4 is a top view of the optical component 1 and the optical element 10, according to certain aspects of the present disclosure. For illustrative purposes, the top cover 230, the module sponge 240, and first frame 222 is removed. The first opening 212a and the second opening 212b have open structures, that is, the structures of the first opening 212a and the second opening 212b are connected to the optical opening 212e. The shape of the first opening 212a corresponds to and is larger than the shape of the first magnetic element 120, and the shape of the second opening 212b corresponds to and is larger than the shape of the second magnetic element 130. The area of the first opening 212a is different from the area of the second opening 212b. When viewed along the main axis O1, the first magnetic element 120 and the second magnetic element 130 are located on two sides of the optical opening 212e.

Since the top plate 212 is made of magnetically permeable material, the first opening 212a located above the first magnetic element 120 and the second opening 212b located above the second magnetic element 130 may lower the attraction force between the first magnetic element 120, the second magnetic element 130 and the top plate 212. This prevents the first magnetic element 120 and the second magnetic element 130 from being attracted to the top plate 212 and affecting the movement of the movable part 100.

The third opening 212c and the fourth opening 212d have closed structures, that is, the structures of the third opening 212c and the fourth opening 212d are not connected to the optical opening 212e. The third opening 212c corresponds to a first guiding element 430 of the guiding assembly 400, and the fourth opening 212d corresponds to a second guiding element 440 of the guiding assembly 400 (see FIG. 2, as will be described in detail below).

Please refer to FIG. 2 again. The outer frame 220 is fixedly disposed on the housing 210 of the fixed part 200, and the magnetic permeability of the outer frame 220 is lower than the magnetic permeability of the top plate 212. When viewed along the main axis O1, the outer frame 220 at least partially overlaps the first opening 212a of the top plate 212.

The outer frame 220 includes a frame opening 221, a first frame 222, and a second frame 224. The frame opening 221 corresponds to the optical opening 212e of the housing 210. The area of the frame opening 221 is smaller than the total area of the first opening 212a, the second opening 212b, and the optical opening 212e. The first frame 222 is located between the second frame 224 and the top plate 212. In some embodiments, the Young's modulus of the first frame 222 is different from the Young's modulus of the second frame 224. In this embodiment, the Young's modulus of the first frame 222 is greater than the Young's modulus of the second frame 224.

The top cover 230 of the fixed part 200 also includes an optical hole 232, a first hole 234, and a second hole 236. The first hole 234 and the second hole 236 also correspond to the first guiding element 430 and the second guiding element 440, which facilitate the positioning of the top cover 230 and the first frame 222.

The module sponge 240 is for absorbing external impacts and protecting the internal structure of the optical component 1. The module sponge 240 has an opening 242. When being assembled, the optical element 10 is sequentially passed through the opening 242 of the module sponge 240, the optical hole 232 of the top cover 230, the optical opening 212e of the top plate 212 of the housing 210, and the frame opening 221 of the outer frame 220.

The driving assembly 300 includes a first magnetic unit 310, a first coil 320, a second magnetic unit 330, a second coil 340, a third magnetic unit 350, a third coil 360, and a fourth magnetic unit 370, and a fourth coil 380. The first magnetic unit 310, the second magnetic unit 330, the third magnetic unit 350, and the fourth magnetic unit 370 have elongated structures and are disposed on the housing 210 of the fixed part 200. The first coil 320, the second coil 340, the third coil 360, and the fourth coil 380 have elongated structures and are disposed on the movable part body 110 of the movable part 100. In other embodiments, the first magnetic unit 310, the second magnetic unit 330, the third magnetic unit 350, and the fourth magnetic unit 370 may be disposed on the movable part body 110 of the movable part 100. While the first coil 320, the second coil 340, the third coil 360, and the fourth coil 380 may be disposed on the housing 210 of the fixed part 200.

The first coil 320 corresponds to the first magnetic unit 310. The second coil 340 corresponds to the second magnetic unit 330. The third coil 360 corresponds to the third magnetic unit 350. The fourth coil 380 corresponds to the fourth magnetic unit 370.

By the electromagnetic driving force generated between the first magnetic unit 310 and the first coil 320, the second magnetic unit 330 and the second coil 340, the third magnetic unit 350 and the third coil 360, the fourth magnetic unit 370 and the fourth coil 380. The movable part 100 may be driven to move relative to the fixed part 200.

Please refer to FIG. 3A again. When viewed along the main axis O1, the first magnetic unit 310 and the first coil 320 extend along a first axis O2, and the second magnetic unit 330 and the second coil 340 extend along a second axis O3. The main axis O1 is perpendicular to the second axis O3. The first axis O2 and the second axis O3 are perpendicular to each other.

In this embodiment, since the length L1 of the movable part body 110 is greater than the width W1, the size of the movable part body 110 on the second axis O3 (i.e., the length L1) is greater than the size of the movable part body 110 on the first axis O2 (i.e., width W1). The movable part body 110 extends along the second axis O3. The housing 210 accommodating the movable part body 110 also extends along the second axis O3. That is, in this embodiment, the size of the housing 210 along the second axis O3 is greater than the size of the housing 210 along the first axis O2.

In some embodiments, when viewed along the main axis O1, the maximum size W2 of the first magnetic unit 310 on the second axis O3 is different from the maximum size W3 of the second magnetic unit 330 on the first axis O2. In this embodiment, the maximum size W2 of the first magnetic unit 310 along the second axis O3 is greater than the maximum size W3 of the second magnetic unit 330 along the first axis O2. The maximum size L2 of the first magnetic unit 310 along the first axis O2 is the same as the maximum size L3 of the second magnetic unit 330 along the second axis O3. The maximum size LA of the first coil 320 on the first axis O2 is the same as the maximum size L5 of the second coil 340 on the second axis O3.

In this embodiment, the first magnetic unit 310 is closer to the first magnetic element 120 than the second magnetic unit 330. The second magnetic unit 330 is closer to the second magnetic element 130 than the first magnetic unit 310.

In some embodiments, the shortest distance d1 between the first magnetic unit 310 and the first magnetic element 120 is different from the shortest distance d2 between the second magnetic unit 330 and the second magnetic element 130. In this embodiment, the shortest distance d1 between the first magnetic unit 310 and the first magnetic element 120 is greater than the shortest distance d2 between the second magnetic unit 330 and the second magnetic element 130. This arrangement allows the attraction force between the second magnetic unit 330 and the second magnetic element 130 greater than the attraction force between the first magnetic unit 310 and the first magnetic element 120, so that the movable part body 110 may lean against the guiding assembly 400 to increase stability during movement.

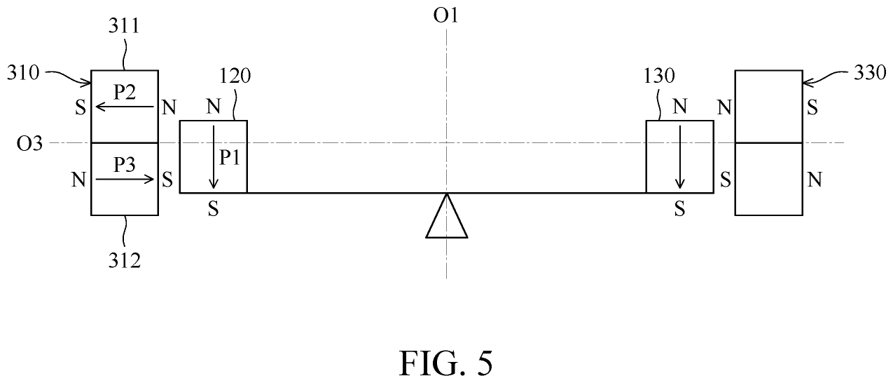

Next, please refer to FIG. 5. FIG. 5 is a schematic diagram of the magnetic distribution of the first magnetic element 120, the second magnetic element 130, the first magnetic unit 310, and the second magnetic unit 330, according to certain aspects of the present disclosure. The magnetic pole direction P1 of the first magnetic element 120 is arranged along the main axis O1. The magnetic pole direction P2 of a first magnetic part 311 and the magnetic pole direction P3 of a second magnetic part 312 of the first magnetic unit 310 are arranged along the second axis O3. The magnetic pole direction P1 of the first magnetic element 120 is perpendicular to the magnetic pole direction P2 of the first magnetic part 311 and the magnetic pole direction P3 of the second magnetic part 312 of the first magnetic unit 310. The magnetic pole direction P3 of the second magnetic part 312 of the first magnetic unit 310 is opposite to the magnetic pole direction P2 of the first magnetic part 311 of the first magnetic unit 310.

Please refer to FIG. 2 and FIG. 3A again. The movable part 100 is movable relative to the fixed part 200 via the guiding assembly 400. The guiding assembly 400 includes the first guide rod 410, the second guide rod 420, the first guiding element 430, and the second guiding element 440. The first guide rod 410 and the second guide rod 420 are located at the second corner 112 and the fourth corner 114.

The first guiding element 430 is located on the first frame 222, adjacent to the first guide rod 410. The first guiding element 430 has an elongated structure, and serves as a positioning post passing through the third opening 212c. The second guiding element 440 is located on the first frame 222, adjacent to the second guide rod 420. The second guiding element 440 has an elongated structure, and serves as a positioning post passing through the fourth opening 212d. The first guiding element 430 and the second guiding element 440 mate with the third opening 212c and the fourth opening 212d to facilitate fixedly connect the first frame 222 and the housing 210. Thereby, the first guiding element 430 and the second guiding element 440 of the guiding assembly 400 position the outer frame 220.

The electronic assembly 500 includes a sensing element 510, a circuit board 520, and a connecting element 530. The sensing element 510 senses the movement of the first magnetic element 120. The circuit board 520 receives the movement information of the movable part 100 from the sensing element 510 and provides current to the driving assembly 300. The connecting element 530 conducts the current to the first coil 320 and the second coil 340, the third coil 360, and the fourth coil 380. Electromagnetic driving force is generated between the powered first coil 320, second coil 340, third coil 360, fourth coil 380 and the first magnetic unit 310, the second magnetic unit 330, the third magnetic unit 350, and the fourth magnetic unit 370. The movable part 100 is moved relative to the fixed part 200, thereby controlling the position of the optical element 10.

In summary, the present invention provides an optical component, which includes a movable part, a fixed part, a driving assembly, a guiding assembly, and an electronic assembly. The movement of the driving assembly drives the movable part to move relative to the fixed part. With this, the position of the optical element may be adjusted to adapt to different external photography needs. At the same time, its magnetically permeable top plate opening structure may also effectively reduce operational errors caused by interference with magnetic elements during operation, stabilize the internal structure, and provide more stable and better optical quality.

Although embodiments of the invention have been shown and described with respect to one or more embodiments, equivalents and modifications will occur to those of ordinary skill in the art upon reading and understanding this specification and the accompanying drawings. Additionally, while particular features of the invention may have been invented with respect to only one embodiment of several embodiments, such features may be combined with one or more of the other embodiments as may be required and advantageous for any given or particular application. Multiple other feature combinations.

Although various embodiments of the present invention have been described above, it should be understood that they are presented by way of example only and not limitation. Various changes may be made in accordance with the embodiments invented herein without departing from the spirit or scope of the invention. Accordingly, the breadth and scope of the present invention should not be limited by any of the above-described embodiments. Rather, the scope of the invention should be defined in accordance with the following claims and their equivalents.

The terminology used herein is for the purpose of describing particular embodiments only and is not intended to be limiting of the invention. As used herein, the singular forms “a, an” and “the” are intended to include the plural forms as well, unless the context clearly indicates otherwise. In addition, the terms “including, includes”, “having, has, with” or variations thereof used in the embodiments and/or patent application scope are intended to be similar to “comprising” is included.

What is claimed is:

1. An optical component, comprising:
a movable part, connecting an optical element;
a fixed part, including a housing, wherein the movable part is movable relative to the fixed part; and
a driving assembly, driving the movable part to move relative to the fixed part.

2. The optical component as claimed in claim 1, wherein the movable part includes a first magnetic element and a second magnetic element, the optical component further comprises a sensing element, and the first magnetic element corresponds to the sensing element; wherein the volume of the first magnetic element is different from the volume of the second magnetic element;
the volume of the first magnetic element is greater than the volume of the second magnetic element.

3. The optical component as claimed in claim 2, wherein:
the fixed part has a main axis;
the housing has an elongated structure, including a top plate;
the top plate is made of magnetically permeable material and has an extension direction that is perpendicular to the main axis;
the magnetic pole direction of the first magnetic element is arranged along the main axis.

4. The optical component as claimed in claim 3, wherein the top plate includes:
a first opening, corresponding to the first magnetic element; and
a second opening, corresponding to the second magnetic element; wherein:
the area of the first opening is different from the area of the second opening;
the shape of the first opening corresponds to the shape of the first magnetic element, and is larger than the shape of the first magnetic element, while the shape of the second opening corresponds to and is larger than the shape of the second magnetic element.

5. The optical component as claimed in claim 4, wherein the driving assembly includes:
a first magnetic unit, having an elongated structure;
a first coil, having an elongated structure, corresponding to the first magnetic unit;
a second magnetic unit, having an elongated structure; and
a second coil, having an elongated structure, corresponding to the second magnetic unit; wherein when viewed along the main axis:
the first magnetic unit and the first coil extend along a first axis; and
the second magnetic unit and the second coil extend along a second axis;
the housing extends along the second axis;
the first axis and the second axis are perpendicular to each other;
the main axis is perpendicular to the second axis.

6. The optical component as claimed in claim 5, wherein:
the first magnetic unit is closer to the first magnetic element than the second magnetic unit;
the second magnetic unit is closer to the second magnetic element than the first magnetic unit;
the shortest distance between the first magnetic unit and the first magnetic element is different from the shortest distance between the second magnetic unit and the second magnetic element;
the shortest distance between the first magnetic unit and the first magnetic element is greater than the shortest distance between the second magnetic unit and the second magnetic element.

7. The optical component as claimed in claim 5, wherein:
the magnetic pole direction of a first magnetic part of the first magnetic unit is arranged along the second axis;
the magnetic pole direction of a second magnetic part of the first magnetic unit is arranged along the second axis;
the magnetic pole direction of the second magnetic part of the first magnetic unit is opposite to the magnetic pole direction of the first magnetic part of the first magnetic unit;
the magnetic pole direction of the first magnetic element is perpendicular to the magnetic pole direction of the first magnetic part and the magnetic pole direction of the second magnetic part of the first magnetic unit.

8. The optical component as claimed in claim 5, wherein when viewed along the main axis:
the maximum size of the first magnetic unit on the second axis is different from the maximum size of the second magnetic unit on the first axis;
the maximum size of the first magnetic unit on the first axis is the same as the maximum size of the second magnetic unit on the second axis;
the maximum size of the first coil on the first axis is the same as the maximum size of the second coil on the second axis.

9. The optical component as claimed in claim 5, wherein when viewed along the main axis, the maximum size of the first magnetic unit on the second axis is greater than the maximum size of the second magnetic unit on the first axis.

10. The optical component as claimed in claim 4, wherein the top plate further includes a third opening and a fourth opening,
the third opening has a closed structure;
the first opening has an open structure.

11. The optical component as claimed in claim 10, further comprising:
a guiding assembly, wherein the movable part is movable relative to the fixed part through the guiding assembly; and
the guiding assembly includes:
a first guiding element, having an elongated structure passing through the third opening; and
a second guiding element, having an elongated structure, passing through the fourth opening.

12. The optical component as claimed in claim 11, wherein the fixed part further includes an outer frame, the guiding assembly positions the outer frame, and the outer frame is fixedly disposed on the fixed part.

13. The optical component as claimed in claim 12, wherein the magnetic permeability of the outer frame is lower than the magnetic permeability of the top plate.

14. The optical component as claimed in claim 12, wherein the outer frame at least partially overlaps the first opening when viewed along the main axis.

15. The optical component as claimed in claim 12, wherein the outer frame includes a first frame and a second frame, the first frame is disposed between the second frame and the top plate, and the Young's modulus of the first frame is different from the Young's modulus of the second frame

16. The optical component as claimed in claim 15, wherein the Young's modulus of the first frame is greater than the Young's modulus of the second frame.

17. The optical component as claimed in claim 12, wherein the top plate further includes an optical opening, and the outer frame includes a frame opening corresponding to the optical opening.

18. The optical component as claimed in claim 17, wherein the structures of the first opening and the second opening are connected to the optical opening.

19. The optical component as claimed in claim 17, wherein the area of the frame opening is smaller than the total area of the first opening, the second opening, and the optical opening.

20. The optical component as claimed in claim 17, wherein the movable part further has a first corner, a second corner, a third corner, and a fourth corner, when viewed along the main axis:
the first magnetic element and the second magnetic element are located on two sides of the optical opening;
the first magnetic element and the second magnetic element are located at the first corner and the third corner, while the first corner and the third corner are opposite corners;
the first guiding element and the second guiding element are located at the second corner and the fourth corner, while the second corner and the fourth corner are opposite corners.
